(19) United States
(12) Patent Application Publication
(10) Pub. No.: US 2010/0122734 A1
(43) Pub. Date: May 20, 2010

(54) MEDICAL GAS LINE APPARATUS AND RELATED METHODS

(76) Inventor: William J. Kaht, Burlington, KY (US)

Correspondence Address: WOOD, HERRON & EVANS, LLP, 2700 CAREW TOWER, 441 VINE STREET, CINCINNATI, OH, 45202, US

(21) Appl. No.: 12/271,264

(22) Filed: Nov. 14, 2008

(51) Int. Cl. F17D 3/00; F16L 15/00

(52) U.S. Cl. 137/15.01; 285/390

(57) ABSTRACT

An apparatus is provided for purging a medical gas line having an outlet that includes a back body having a bore in communication with the gas line. An elongate body includes a distal portion and a proximal portion. The distal portion is configured for insertion within a bore of a back body of an outlet of the medical gas line. The distal portion includes a first port and the proximal portion includes a second port that is in fluid communication with the first port for permitting the flow of gas through the elongate body from or toward the bore.

### TECHNICAL FIELD

This invention is generally related to apparatus and methods for purging a medical gas line and, more particularly, to apparatus and methods for purging a gas line during installation of an outlet.

### BACKGROUND

Medical gas lines typically found in a hospital room or similar environment include an outlet located on a wall providing access to a source of gas, such as oxygen, or a source of vacuum, for example. Conventional outlets of this type include a back body that is supported from a supporting structure of a wall, such as a wooden or metal stud and a front assembly. A check valve may extend outwardly into the room from the front assembly and is coupled to the back body to control the flow of gas in only one direction.

During installation of outlets of this type, it is sometimes necessary to form joints between metal (e.g., copper) tubes, for example, that are located upstream of the outlet. In order to prevent contamination of the check valve and other portions of the front assembly, all joining of the tubes is done in the absence of all or part of the front assembly (e.g., the check valve). Such tube joining operations may, for example, include brazing, which may result in oxidation of some of the metals involved in the joining process. In order to minimize such oxidation, certain codes, regulations, standards or simply common practice in the industry may require purging of the gas lines upstream of the outlet prior to the brazing operation, for example, with pure, dry nitrogen.

Purging of the gas lines may require the displacement of a spring-biased cap in a bore of the outlet. The spring-biased cap in outlets of this type blocks access to the gas line in the biased position. Conventionally, the cap is pushed open by wedging a screw-driver or some other tool in the bore of the outlet and the nitrogen is purged in a single direction, namely, from an area upstream of the outlet toward an area downstream thereof (e.g., into the hospital room).

Conventional purging, accordingly, is cumbersome and inconsistent. For example, the screw driver or other tool wedged in the bore may normally have a tendency to fall out of the bore during purging, thus requiring manual support of the screw driver during purging. Likewise, the process of purging is not easily repeatable as the depth of insertion of the wedging of the screw driver is not always consistent from one outlet to another.

Further, wedging of the screw driver may limit conventional purging to a single direction of gas flow, namely, from upstream to downstream of the outlet. It is desirable, therefore, to have apparatus and related methods that address these and other challenges of conventional apparatus and methods used to purge medical gas lines of the types described above.

### SUMMARY

In one embodiment, an apparatus is provided for purging a medical gas line having an outlet that includes a back body having a bore in communication with the gas line. An elongate body of the apparatus includes a distal portion and a proximal portion. The distal portion is configured for insertion within the bore. The distal portion includes a first port and the proximal portion includes a second port that is in fluid communication with the first port for permitting the flow of gas through the elongate body. The elongate body may permit bi-directional flow of gas between the first and second ports.

The apparatus may include a gripping portion that is associated with the proximal portion of the elongate body for rotating the same. The gripping portion may, for example, include a hexagonal socket head bore at a proximal end of the elongate body. The second port may be disposed at a proximal end of the elongate body. The first port may be positioned in the distal portion to be in confronting relationship with a spring-biased cap of the outlet, with the distal portion being sized to engage the cap of the outlet to thereby actuate the flow of gas through the first port while permitting the first port to be unobstructed when the distal portion is in contacting engagement with the cap.

The apparatus may include a third port in the distal portion that is in fluid communication with the first port. The distal portion may include a first thread configured to engage a thread of the bore. Additional or alternatively, the proximal portion may include a second thread that is configured for engagement with a gas line fitting.

The apparatus may include a support member having a threaded aperture and configured for coupling with the back body of the outlet, with the distal portion having a first thread configured for coupling with the support member through the aperture. The support member may include at least one of a magnetic element or a fastener-receiving channel for releasably engaging the support member to the back body of the outlet. The back body may include a protruding portion adjacent the bore, with the support member including a recess sized to receive the protruding portion therein to thereby permit abutting contact between the support member and the back body. The apparatus may include a gripping portion cooperating with the support member to limit a depth of insertion of the elongate body into the bore.

In another embodiment an apparatus is provided for purging a medical gas line having an outlet that includes a back body having a bore in communication with the gas line. The apparatus includes a block having a threaded aperture and configured for coupling with the back body. The block includes a magnetic element for releasably coupling the block to the back body and a recess to receive a protruding portion of the back body adjacent the bore therein thereby permitting abutting contact between the block and the back body. The apparatus includes a plunger that includes a distal portion and a proximal portion, and a thread on the distal portion, with the thread being coupled to the block through the threaded aperture for support of the plunger within the bore of the back body. The distal portion includes a first port and the proximal portion includes a second port that is in fluid communication with the first port for permitting the flow of gas through the plunger. A third port in the distal portion is in fluid communication with the second port.

The distal portion of the plunger may have an end that is configured to engage a spring-biased cap of the outlet in the bore of the back body to thereby actuate the flow of gas through the first and third ports, with at least one of the first or third ports being unobstructed during contacting engagement of the end of the plunger with the cap. The apparatus may include a tool-gripping portion that is associated with the proximal portion for rotating the plunger, with the tool-gripping portion including a detent cooperating with the block to limit a depth of insertion of the plunger into the bore. The block may include a pair of channels, each adapted to receive a fastener there along for releasably coupling the block relative to the back body of the outlet.

In yet another embodiment a medical gas line assembly is provided that includes a medical gas line outlet back body adapted for coupling with a wall in a room. The back body has a bore for providing access to the gas line. A pipe is coupled to the back body and is in fluid communication with the bore to permit the flow of gas between the pipe and through the bore. A support member is releasably coupled to the back body and includes a threaded aperture there through. A plunger is threadably coupled to the aperture and includes distal and proximal portions and first and second ports respectively in the distal and proximal portions and in fluid communication with one another to permit flow of gas through the plunger. The distal portion is adapted to engage a biased cap in the bore of the back body to actuate the flow of gas through the pipe and the first port. The plunger may have a length, for example, no greater than about one inch.

In another embodiment, a method is provided for purging a medical gas line through a back body of an outlet. The method includes supporting a valveless apparatus within a bore of the outlet providing access to a gas passage. The valveless apparatus is rotated to displace a biased cap of the outlet in the bore, with displacement of the biased cap opening access to the gas passage. The method includes feeding a gas through the gas passage and through first and second ports of the valveless apparatus.

### BRIEF DESCRIPTION OF THE DRAWINGS

FIG. 1 is a perspective view of an exemplary embodiment of a medical gas line assembly in accordance with the principles of the present invention;

FIG. 2 is a perspective, partially disassembled view of the assembly of FIG. 1;

FIG. 3A is a cross-sectional view taken generally along line 3A-3A of FIG. 1;

FIG. 3B is a view similar to FIG. 3A showing a plunger of the assembly in a position different from that shown in 3A;

FIG. 3C is a cross-sectional view taken generally along line 3C-3C of FIG. 3B;

FIG. 4 is a partially disassembled perspective view of a different embodiment of a medical gas line assembly;

FIG. 4A is a partially disassembled perspective view of yet another different embodiment of a medical gas line assembly;

FIG. 5 is a perspective, partially disassembled view of an embodiment of an apparatus for purging a medical gas line;

FIG. 6 is a cross-sectional view taken generally along line 6-6 of FIG. 5;

FIG. 7 is an elevational view of the apparatus of FIG. 5; and

FIG. 8 is a perspective, partially disassembled and partially broken-away view of another embodiment of a medical gas line assembly.

### DETAILED DESCRIPTION

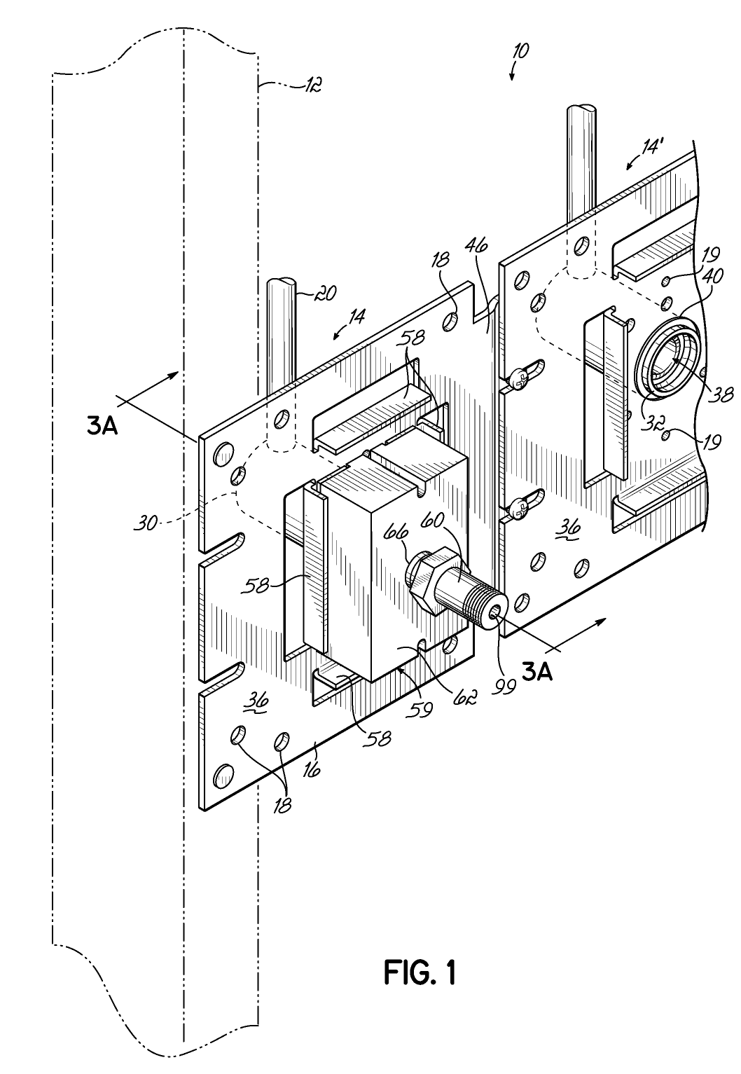

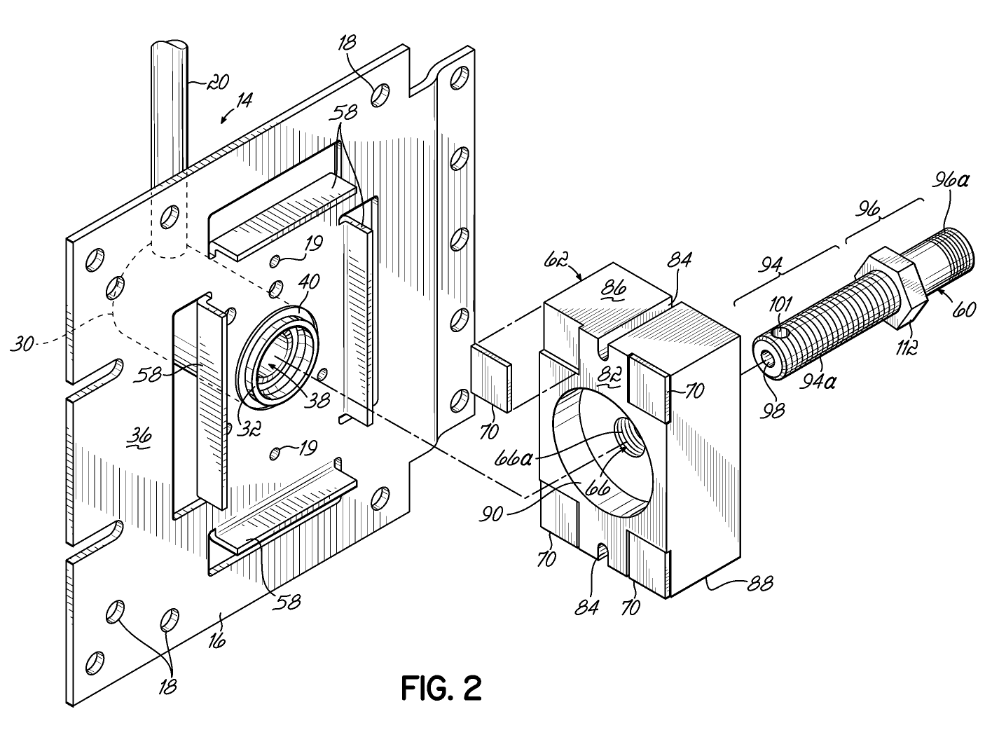

With respect to the figures, and particularly to FIGS. 1-2, a medical gas line assembly 10 is supported by a wall supporting structure such as a stud 12. The medical gas line assembly 10 includes a back body 14 that is substantially made of a metal, such as brass, for example. The back body 14 includes a generally flat body 16 having one or more orifices 18 that receive fasteners such as screws or bolts (not shown) for securing the back body 14 to the stud 12. A set of additional apertures 19 on the flat body 16 permit securing an outlet cover (not shown) to the flat body 16 from which a check valve or similar device (not shown) extends.

Jointly, the back body 14 and the front assembly (not shown, including the check valve or another similar device) define an outlet of the medical gas line assembly 10. A pipe 20 extends from the back body 14 and fluidly communicates with a source of gas or a gas-receiving target in an area upstream of the pipe 20. In use, for example, and without limitation, the pipe 20 may be coupled to a source of oxygen that feeds oxygen into a hospital room through the outlet. Alternatively, and also without limitation, the pipe 20 may be coupled to a source of vacuum to thereby provide a source of suction for air in the room. As used herein, the term “outlet” thus refers to outlets, as described herein, as well as devices that may be alternatively known as “inlets” coupled to the above-referenced source of vacuum.

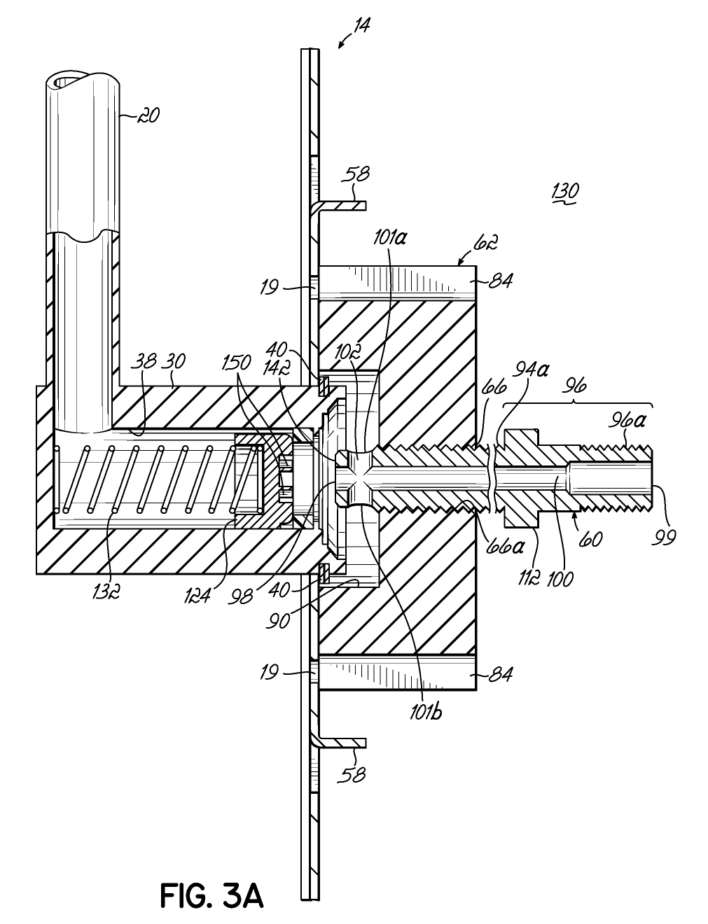

The pipe 20 is coupled to the back body 14 through a cylindrical housing 30, shown in phantom in FIGS. 1-2 coupled to the flat body 16 at a proximally-facing end 32 of the housing 30 that protrudes through an aperture 34 (FIG. 3A) of the flat body 16 and is exposed to a proximal side 36 of the flat body 16. A retainer ring 40 surrounds the aperture 34 and is partially received within an annular recess (not shown) at the end 32 of the housing 30 to thereby secure the pipe 20 and housing 30 from axial movement (i.e., along the length of the housing 30) relative to the flat body 16. The housing 30 thus defines a bore 38 of the back body 14.

With continued reference to FIGS. 1-2, the flat body 16 may include one or more lateral projections 46 permitting coupling of the back body 14 with adjacent structures such as an additional back body 14′ of an adjacent outlet, as generally shown in FIG. 1. A plurality of proximally projecting segments 58 define a space of the back body 14 that receives the outlet cover (not shown). Examples of components such as those described above are, for example, available from the Amico Corporation of Ontario, Canada, under part No. 6-233110.

An apparatus for purging the medical gas line, for example to remove debris and/or oxide material from a pipe coupling upstream of the pipe 20, is generally designated with the numeral 59 and includes a plunger 60 threadably coupled to a support member in the form of a block or plate 62 through a threaded aperture 66 of the block 62. The plunger 60 may be made of any suitable material such as, and without limitation, metal, plastic, or wood. In this particular embodiment, for example, the plunger 60 is made of a plastic such that the plunger 60 may be either cleaned, washed, or discarded after use, if so desired, and be of generally low cost. As explained in further detail below, the plunger 60 fluidly communicates with the interior of the housing 30 to allow gas, such as oxygen or pure, dry nitrogen, to flow through the back body 14 and thereby purge the gas line. The block 62, as explained below, cooperates with the flat body 16 to support the plunger 60 and limit the insertion depth thereof into the housing 30 through the bore 38.

In a specific embodiment, the block 62 is releasably coupled to the back body 14 during installation of the medical gas line to facilitate purging of the gas line. To this end, the block 62 includes one or more magnetic elements that facilitate such coupling. In this particular embodiment, the magnetic elements are in the form of four magnets 70 disposed at the corners of the block 62 on the distally-facing side 82 thereof (see FIG. 2). The magnets 70 permit releasable coupling of the block 62 to a ferrous flat body 16 or at least to ferrous portions or components of the flat body 16. It is contemplated, in the alternative or in addition, that the magnetic elements of the block 62 may be in the form of ferrous metallic components that are engageable with correspondingly-located magnets forming part of the back body 14.

With continued reference to FIGS. 1-2, releasable coupling between the block 62 is further facilitated by a pair of generally U-shaped channels 84 extending generally along the top and bottom faces 86, 88 of the block 62 and configured to receive respective fasteners such as screws or bolts (not shown). More specifically, the fasteners, if used, engage a corresponding pair of the apertures 19 of the flat body 16 to thereby temporarily secure (i.e. during installation of the gas line assembly) the block 62 to the back body 14. It is contemplated that an alternative block may include channels having other shapes, locations and/or in a different number or include no such channels at all.

Coupling of the block 62 is also facilitated by a recess 90 on the distally-facing side 82. More particularly, the recess 90 is generally shaped and sized to receive the end 32 of the housing 30 and the retainer ring 40 during coupling engagement with the back body 14. This coupling thus permits abutting contact between the distally-facing side 82 of the block 62 and the flat body 16 of the back body 14, as best appreciated in FIGS. 3A-3C.

With continued reference to FIGS. 1-2 and further referring to FIGS. 3A-3C, the plunger 60 has a generally elongate body and includes a distal portion 94 and a proximal portion 96. A distally located first port 98 of the plunger 60 is in fluid communication with a proximally located second port 99 through an internal axial lumen 100 (FIGS. 3A-3C) and permits the flow of gas through the plunger 60. Each of a pair of distally located third and fourth ports 101a, 101b is in fluid communication with one another and with the first and second ports 98, 99. The third and fourth ports 101a, 101b communicate with one another through an internal transverse lumen 102 and communicate with the first and second ports 98, 99 through the axial lumen 100.

During coupling engagement of the plunger 60 with the bore 38 of the back body 14, the distal portion 94 threadably engages the threaded aperture 66 of the block 62 and extends into the bore 38. To this end, the distal portion 94 includes a first thread 94a that matches a thread 66a of the aperture 66. Rotation of the plunger 60, accordingly, results in axial movement (along an axis 60a of the plunger 60) thereof through the aperture 66 and into the bore 38. Rotation of the plunger 60 is facilitated by a gripping portion in the form, in this exemplary embodiment, of a male hexagonal tool-gripping portion 112 associated generally with the proximal portion 96 of the plunger 60. The tool-gripping portion 112 is sized and shaped to permit rotation of the plunger 60 either by hand or by a suitable tool such as a wrench, pliers or another type of tool. A second thread 96a of the proximal portion 96 permits coupling of the plunger 60 to gas line fittings or similar devices to aid in the flow of gas between the hospital room and areas upstream of the pipe 20, if so desired by the user.

Purging of the gas medical line is described with particular reference to the sequence illustrated in FIGS. 3A, 3B, and 3C. In FIG. 3A, the plunger 60 is illustrated being threadably engaged with the aperture 66 of the block 62 and extending through the block 62 partially into the bore 38 of the back body 14. In the figure, a spring-biased cap 124 in the bore 38 is shown in an extended position, blocking access to the flow of gas to (or from) the pipe 20 from (to) an area generally assigned the numeral 130 and which corresponds to an interior of the hospital room or the like. The spring-biased cap 124 is biased by a coil spring 132 disposed in the housing 30 and located distally of the cap 124. The axial position of the plunger 60 in FIG. 3A is such that a distal end 142 thereof is slightly spaced from the cap 124.

With specific reference to FIGS. 3B-3C, the plunger 60 is illustrated in an axial position further within the bore 38 relative to the position shown in FIG. 3A. More specifically, the distal portion 94 of the plunger 60 is shown having distally displaced the cap 124 and being in contacting engagement with a first plurality of wings 150 extending proximally from the cap 124. In this regard, the distal end 142 of the plunger 60 is sized and shaped to engage the wings 150, thereby actuating the flow of gas, without obstructing the first port 98, as illustrated in FIG. 3B. This engagement compresses the coil spring 132, moving the cap 124 distally (arrow 160, generally), and permitting the flow of gas through the plunger 60 and the pipe 20. More specifically, gas flows through the unobstructed first, third, and fourth ports 98, 101a, 101b at the distal end 142 of the plunger 60, through gaps 164 (one shown in FIG. 3B) between a second plurality of wings 170 of the cap 124 and the housing 30, and through the second port 99 in the proximal portion 96 of the plunger 60. An exemplary flow of gas is schematically and generally illustrated with arrows 178.

During use, such as when purging the gas line to remove debris (e.g., oxide) associated with a brazing operation or to purge air to replace with a gas such as nitrogen, the gas flows through pipe 20, through the housing 30, and through the plunger 60 towards the area 130. In this regard, the gas carries therewith any debris that may be present, and is expelled towards area 130. The purging operation is performed until the flow of gas indicates that debris is no longer present in the gas line, including the pipe 20 and housing 30. Alternatively, the purging operation is performed until oxygen is no longer detected in the gas line. Once the purging is completed, the plunger 60 may be discarded, if so desired, with at least some of the debris retained on its surfaces. In the alternative, the plunger 60 may be cleaned, if needed, and subsequently reused. While the exemplary purging herein described suggests a flow of gas from an upstream area (upstream of the pipe 20) and toward the area 130 in the interior of the hospital room, it is contemplated that the purging may include the flow of gas in the opposite direction, which is facilitated by the bi-directional nature of the plunger 60 and its secure engagement within the bore 38. Moreover, purging may involve the flow of a gas other than nitrogen. In purging operations involving the flow of gas in the opposite direction, the threads 96a permit coupling of a gas line fitting coupled, for example, to a source of nitrogen, such that purging may be effected in such direction away from the area 130.

Purging may include the use of nitrogen that is made to flow through the gas line until oxygen is no longer detected in the gas line, for example, as mandated by a code, regulation, or standards pertaining to a particular application in the health care industry or similar. An example of such codes, regulations or standards may be found in publications by the National Fire Protection Association (“NFPA”) or by the International Organization for Standardization (“ISO.”) The oxygen in the gas line may be detected or measured, for example, with an oxygen concentration probe connected to an oxygen analyzer. Notably, the plunger 60 of this embodiment includes a portion 180 of the axial lumen 100 that is sized and shaped to receive a probe 181 to facilitate such measurement by a schematically represented instrument 182. In this embodiment, for example, the portion 180 has a length of about ⅝ of an inch and a diameter of about ¼ of an inch, although this is merely illustrative as other alternative dimensions are similarly contemplated. The portion 180 may additionally or alternatively be sized and shaped to receive a different type of probe to measure other quality characteristics of the gas in the gas line flowing through the plunger 60.

With particular reference to FIG. 3B, and as noted above, the gripping portion 112 cooperates with the block 62 to limit axial displacement of the plunger 60 into the bore 38. More specifically, a distally-facing surface 112a of the tool-gripping portion 112 abuts a proximally-facing face 186 of the block 62 such that further distal advancement of the plunger 60 is precluded. Accordingly, the tool-gripping portion 112 provides a detent or limiting feature that predetermines the maximum insertion depth of the plunger 60 into the bore 38.

While the plunger 60 described above includes a total of three ports generally at the distal end 142, it is contemplated that it may alternatively include ports in any number located and/or oriented in configurations different from those shown. For example, and without limitation, an alternative plunger may include a single port at the distal end. Likewise, it is contemplated that an alternative plunger may include ports at its proximal end in any number other than one or have a single port oriented differently from the exemplary orientation of the second port 99 of the plunger 60.

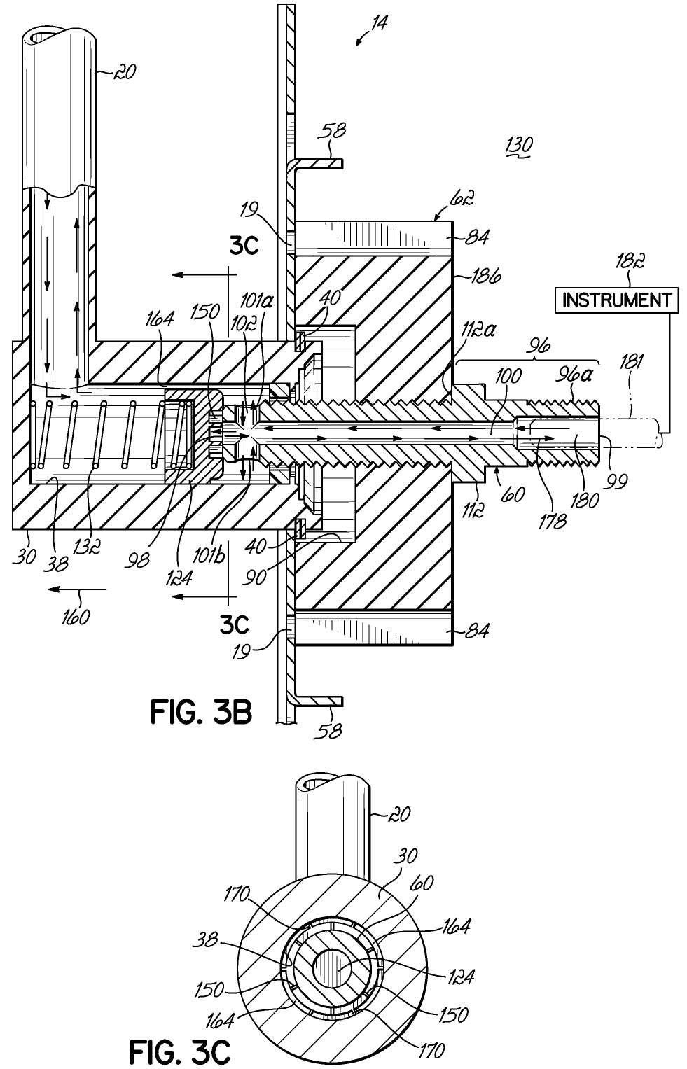

With reference to FIG. 4, an alternative embodiment of a medical gas line assembly 250 includes a back body 254 of an outlet that has a form different from that shown in the preceding figures. The back body 254 may, for example, take the form of an outlet back body available from the Amico Corporation of Ontario, Canada. For ease of understanding, like reference numerals in FIG. 4 refer to like features in FIGS. 1-3C. The back body 254 includes two proximally projecting segments 258 each having a vertical flange portion 262. The assembly includes a purging apparatus 270 having a block 62 and plunger 60 similar to those described above with respect to the preceding figures. The block 62, in this embodiment, is illustrated being releasably coupled to the back body 254 through a pair of screws 276 received along the corresponding channels 84. As it can be ascertained from FIGS. 1-4, the purging apparatus 270 is sufficiently versatile to work generally as described above with more than one type of back body, such as back bodies 14, 254. Accordingly, the description of the structure and functionality of the assembly of FIGS. 1-3A may be referred to for an understanding of the assembly 250 as well.

With reference to FIG. 4A, in which like reference numerals refer to like features of FIG. 4, an alternative embodiment of a medical gas line assembly 250a includes a purging apparatus 270a similar to purging apparatus 270 of FIG. 4 but including a pair of channels 84a relatively longer than the channels 84 of purging apparatus 270. The purging apparatus 270a, moreover includes a supporting structure in the form of a plate 286 and a pair of generally concentric, proximally extending portions 287, 289. Notably, the portions 287, 289 permit a reduction, relative to the block 62 of FIG. 4, in the overall weight and size of the supporting member of the purging apparatus 270a. More particularly, the portions 287, 289 provide a sufficient length for the threaded aperture thereof to thereby firmly support the plunger 60.

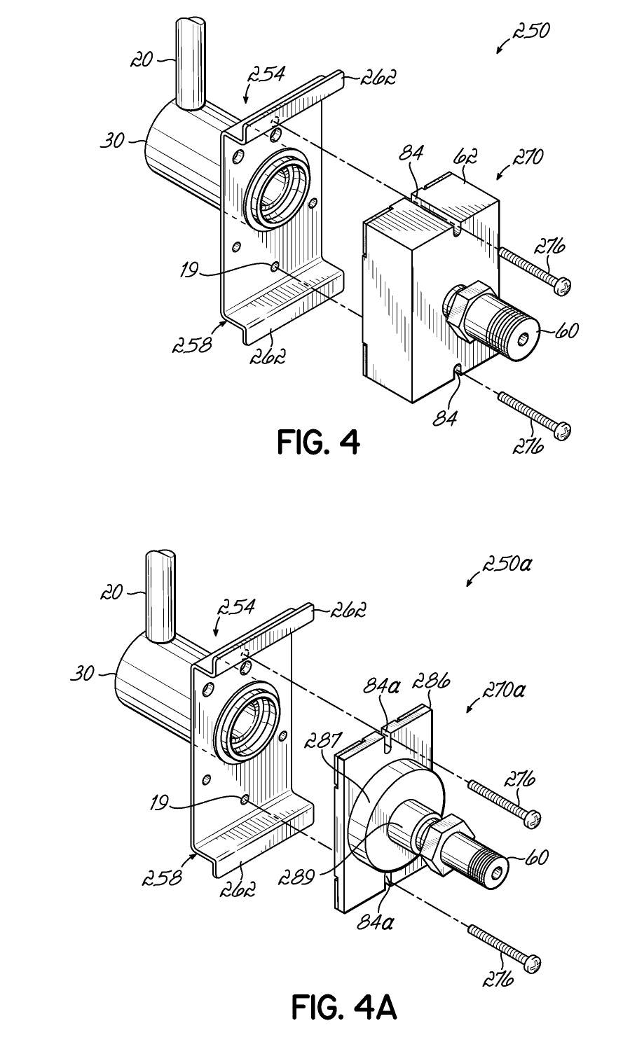

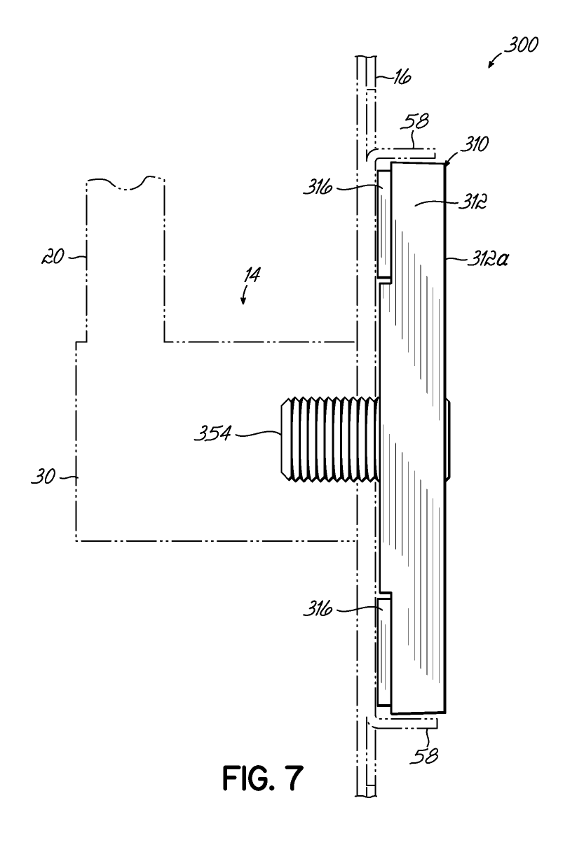

With reference to FIGS. 5-7, in which like reference numerals refer to like features in the preceding figures, another embodiment of a medical gas line assembly 300 (FIG. 7) includes a purging apparatus 310 having a support member in the form of a block 312 that is thinner relative to the block 62 of FIGS. 1-4. The block 312 of this embodiment includes a pair of magnets 316 at the top and bottom thereof for releasable coupling with a back body 14 of an outlet (FIG. 7). The block 312 includes a recess 330 similar to the recess 90 of the preceding embodiments and which includes a centrally located distally protruding portion 334 that is axially sized to abut the flat body 16 of the back body 14. The protruding portion 334 provides a suitable length for a thread 336a of an aperture 336 of the block 312 that is similar to the aperture 66 of FIGS. 1-4.

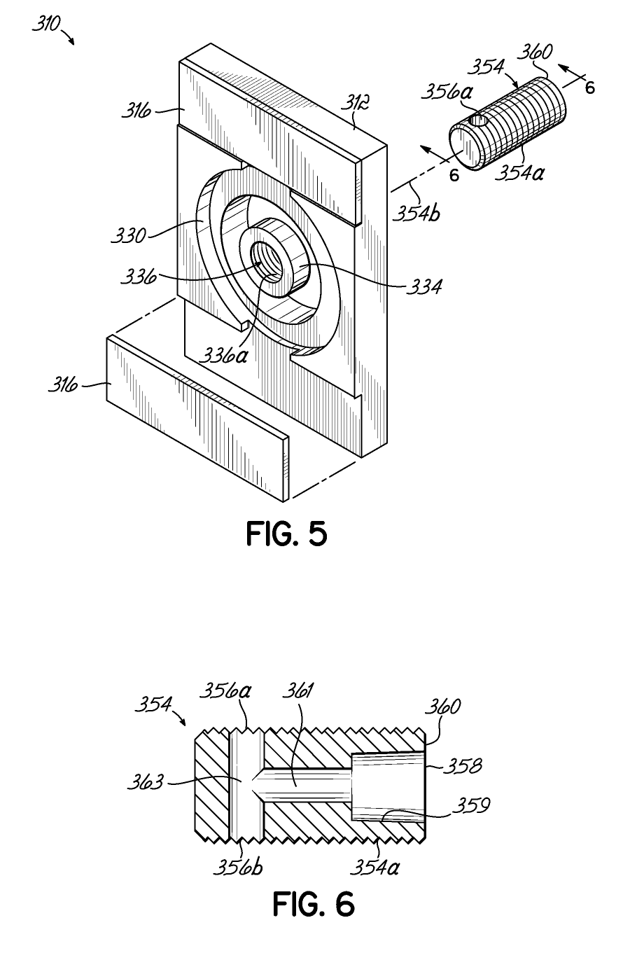

The medical gas line assembly 300 includes a plunger 354 having a thread 354a and a pair of opposed distal ports 356a, 356b, and a single proximal port 358 (FIG. 6). The distal ports 356a, 356b are located similarly to the third and fourth ports 101a, 101b of the plunger 60, while the proximal port 358 is located similarly to the second port 99 of the plunger 60 (FIGS. 1-4). The plunger 354 of this embodiment is relatively short compared to the plunger 60 of FIGS. 1-4. For example, and without limitation, the length (i.e., along the axis 354b) of the plunger 354 may be of about one inch or less.

With particular reference to FIG. 6, the plunger 354 includes a gripping portion in the form of a female hexagonal socket head 359 at the proximal end 360 of the plunger 354, configured to receive a tool such as a hexagonal shaped wrench to thereby facilitate rotation of the plunger 354. The ports 356a, 356b, and 358, as illustrated, are in fluid communication with one another through lumens 361, 363, to permit the flow of gas through the plunger 354 generally in the manner described above with respect to the embodiment of FIGS. 1-4.

With particular reference to FIG. 7, the length of the plunger 354 is suitably chosen to be substantially flush with the proximally-facing face 312a of the block 312 when the plunger 354 is fully inserted within the bore 38. Accordingly, the purging apparatus 310 defined by the block 312 and the plunger 354 can be packaged and distributed as a pre-assembled unit with the back body 14 with a minimum or negligible amount of additional packaging space than what is already devoted to packaging of the back body 14 alone. The length of the plunger 354, moreover, is suitably chosen to be sufficient so as to remain rigidly threadably engaged with the threads 336a of the aperture 336 (FIG. 5) of the block 312 and still be able to displace the cap 124 (FIGS. 3A-3C) to actuate the flow of gas through the back body 14 and the plunger 354.

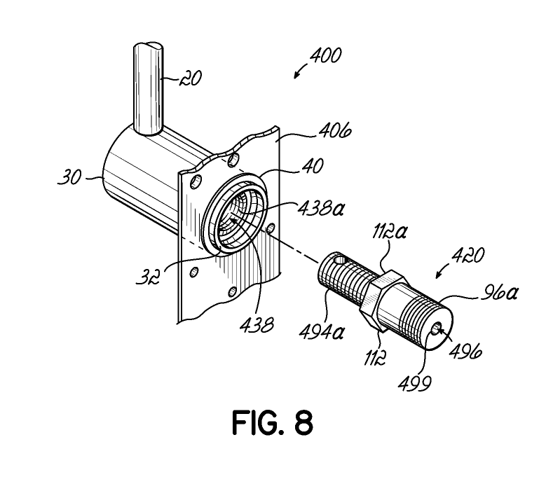

With particular reference to FIG. 8, in which like reference numerals refer to like features in FIGS. 1-7, yet another embodiment of a medical gas line assembly 400 includes a back body 406 that may, for example be similar to either of the back bodies 14, 254 illustrated in FIGS. 1-7, the description of which may be referenced for an understanding of the back body 406 of this embodiment as well. The back body 406 of the assembly 400 includes a bore 438 similar to bore 38 of FIGS. 1-7 but which further includes a thread 438a. A purging apparatus 420 is similar to that described with reference to the embodiment of FIGS. 1-4 but does not include a separate supporting structure. In this regard, therefore, the purging apparatus 420 is in the form of a plunger similar to the plunger 60 described with reference to the embodiment of FIGS. 1-4 and includes a thread 494a configured to threadably engage the thread 438a of the bore 438.

An axial lumen 496 extends from the second port 499 of the apparatus 420 and may have a suitably chosen diameter such as, for example, about ¼ of an inch. In this exemplary embodiment, the distally-facing surface 112a of the tool-gripping portion 112 directly abuts the proximally-facing end 32 of the housing 30 to thereby predetermine the maximum insertion depth of the plunger 420 into the bore 38. Notably, the plunger 420 does not require a support member such as block 62, 312 due to the threaded engagement between the plunger 420 and the bore 438. In this regard, therefore, the plunger 420 is self-supporting within the bore 438.

While the all of the above embodiments include back bodies of outlets each having a spring-biased cap, it is contemplated that other types of caps may be present or even no cap at all. The plungers herein described, therefore, are contemplated to work with such alternative back bodies and still fall within the scope of the present disclosure. An alternative back body, for example, may be associated with a Waste Anaesthetic Gas Disposal (“WAGD”) which may require no cap at all. In such alternative embodiments, accordingly, the plunger or the combination of the plunger and block, may facilitate purging in either direction i.e., from an area generally upstream of the pipe 20 and toward the area 130 in the interior of the hospital room or viceversa. Likewise, while some of the above embodiments include support members in the form of blocks or plates, it is contemplated that alternative support members may take any other suitable shapes or structures so long as they provide a way to support the respective plunger within the bore of the back body of the outlet.

While the above embodiments describe back bodies supported directly by a stud or similar wall supporting structure, it is contemplated that they may alternatively be supported by a headwall or a ceiling service unit and still fall within the scope of the present disclosure. Exemplary headwalls and ceiling service units, may for example be configured for coupling to and support from a wall in a room (e.g., a side wall or ceiling).

From the above disclosure of the general principles of the present invention and the preceding detailed description of exemplary embodiments, those skilled in the art will readily comprehend the various modifications to which this invention is susceptible. Therefore, this invention is intended to be limited only by the scope of the following claims and equivalents thereof.

What is claimed is:

1. An apparatus for purging a medical gas line having an outlet with a back body having a bore in communication with the gas line, said apparatus comprising:
an elongate body including a distal portion and a proximal portion, said distal portion configured for insertion within the bore;
a first port in said distal portion; and
a second port in said proximal portion and in fluid communication with said first port for permitting the flow of gas through said elongate body.

2. The apparatus of claim 1, further comprising:
a gripping portion associated with said proximal portion for rotating said elongate body.

3. The apparatus of claim 2, wherein said gripping portion includes a hexagonal socket head at a proximal end of said elongate body.

4. The apparatus of claim 1, wherein said second port is disposed at a proximal end of said elongate body.

5. The apparatus of claim 1, wherein said outlet includes a spring-biased cap in said bore, said first port being positioned in said distal portion to be in confronting relationship with the spring-biased cap, said distal portion being sized to engage the cap to thereby actuate the flow of gas through said first port while permitting said first port to be unobstructed when said distal portion is in contacting engagement with the cap.

6. The apparatus of claim 1, further comprising:
a third port in said distal portion and in fluid communication with said first port.

7. The apparatus of claim 1, wherein said distal portion includes a first thread configured to engage a thread of the bore.

8. The apparatus of claim 1, wherein said proximal portion includes a second thread configured for engagement with a gas line fitting.

9. The apparatus of claim 1, further comprising:
a support member having a threaded aperture and configured for coupling with the back body of the outlet, said distal portion including a first thread configured for coupling with said support member through said aperture.

10. The apparatus of claim 9, further comprising:
a releasable coupling between said support member and said back body.

11. The apparatus of claim 10, wherein said releasable coupling includes at least one of a magnetic element or a fastener-receiving channel for releasably engaging said support member to the back body of the outlet.

12. The apparatus of claim 9, wherein the back body includes a protruding portion adjacent the bore, said support member including a recess sized to receive the protruding portion therein to thereby permit abutting contact between said support member and the back body.

13. The apparatus of claim 9, further comprising:
a gripping portion associated with said proximal portion for rotating said elongate body, said gripping portion including a detent cooperating with said support member to limit a depth of insertion of said elongate body into said bore.

14. The apparatus of claim 13, wherein said proximal portion includes a conduit adapted to receive a probe therein for measuring a quality characteristic of the gas flowing through said elongate body.

15. The apparatus of claim 1, wherein said elongate body allows for bi-directional gas flow between said first and second ports.

16. An apparatus for purging a medical gas line having an outlet that includes a back body having a bore in communication with the gas line, said apparatus comprising:
a block having a threaded aperture and configured for coupling with the back body, said block including a magnetic element for releasably coupling said block to the back body and a recess to receive a protruding portion of the back body adjacent a bore thereof to thereby permit abutting contact between said block and the back body;
a plunger including a distal portion and a proximal portion, and a thread on said distal portion, said thread of said distal portion coupled to said block through said threaded aperture for support of said plunger within the bore;
a first port in said distal portion;
a second port in said proximal portion and in fluid communication with said first port for permitting the flow of gas through said plunger; and
a third port in said distal portion and in fluid communication with said second port.

17. The apparatus of claim 16, wherein said back body includes a spring-biased cap in the bore, said distal portion of said plunger has an end configured to engage the cap to thereby actuate the flow of gas through said first and third ports, at least one of said first or third ports being unobstructed during contacting engagement of said end with the cap.

18. The apparatus of claim 16, further comprising:
a tool-gripping portion associated with said proximal portion for rotating said plunger, said tool-gripping portion including a detent cooperating with said block to limit a depth of insertion of said plunger into the bore.

19. The apparatus of claim 16, wherein said block includes a pair of channels each adapted to receive a fastener there along for releasably coupling said block relative to the back body of the outlet.

20. A medical gas line assembly, comprising:
a medical gas line outlet back body adapted for coupling with a wall in a room and having a bore providing access to the gas line;
a pipe coupled to said back body and in fluid communication with said bore to permit the flow of gas between said pipe and through said bore;
a support member releasably coupled to said back body and including a threaded aperture there through; and
a plunger threadably coupled to said aperture and including distal and proximal portions and first and second ports respectively in said distal and proximal portions and in fluid communication with one another to permit flow of gas through said plunger, said distal portion being adapted to engage a biased cap in said bore of said back body to actuate the flow of gas through said pipe and said first port.

21. The apparatus of claim 20, wherein said plunger has a length no greater than about one inch.

22. A method of purging a medical gas line through a back body of an outlet, the method comprising:
supporting a valveless apparatus within a bore of the outlet providing access to a gas passage;
rotating the valveless apparatus to displace a biased cap of the outlet in the bore, displacement of the biased cap opening access to the gas passage; and
feeding a gas through the gas passage and through first and second ports of the valveless apparatus.
